(19) United States
(12) Patent Application Publication
(10) Pub. No.: US 2008/0304114 A1
(43) Pub. Date: Dec. 11, 2008

(54) SCANNING MODULE

(76) Inventors: Kuo-Kuang Wu, Hsinchu (TW); Yueh-Shing Lee, Hsinchu (TW); Te-You Chu, Hsinchu (TW)

Correspondence Address: BIRCH STEWART KOLASCH & BIRCH, PO BOX 747, FALLS CHURCH, VA, 22040-0747, US

(21) Appl. No.: 11/758,572

(22) Filed: Jun. 5, 2007

(51) Int. Cl. H04N 1/04

(52) U.S. Cl. 358/497

(57) ABSTRACT

A scanning module includes a contact image sensor unit and a supporting base. The contact image sensor unit has a top surface, a bottom surface, a front surface and a back surface. The supporting base has a guiding portion, a positioning board mounted on the guiding portion, the two sides of the positioning board extends sideward and bends upward to form an elastic arm respectively, the contact image sensor unit is placed on the positioning board and the elastic arm elastically contacts the bottom surface of the contact image sensor unit. The two sides of the supporting base of the scanning module have an elastic arm respectively, the elastic arm contacts the contact image sensor unit directly and makes sure that the contact image sensor unit contacts the glass tightly.

### BACKGROUND OF THE INVENTION

1. Field of the Invention

The present invention relates to a scanning module, and more particularly to a CIS (Contact Image Sensor) scanning module.

2. The Related Art

Scanner is an input device of the computer, which scans the picture, the photo, the film and the document and inputs the scanning image into the computer. Recent scanner includes CCD (Charge-Coupled Device) scanner and CIS (Contact Image Sensor) scanner. The CCD scanner focuses the light on an optic lens module, the light signal is converted into electrical signal and forms the image. The CIS scanner doesn't need the optic lens module, as a result, the power is saved and the volume is smaller than that of the CCD scanner, so the CIS scanner is portable in requirement. In recent years, the technology of the CIS scanner is developing.

Please refer to FIG. 1, a conventional CIS scanning module includes a sensor unit 41 for reading the image, a frame 42 for supporting the sensor unit 41, a guiding portion 43 for guiding the sensor unit 41 to slide smoothly along a lever, a long-wearing piece 44 and a spring 45. The spring 45 makes the sensor unit 41 contact closely with a glass for acquiring an image of good quality. The long-wearing piece 44 is arranged on the sensor unit 41 for making the sensor unit 41 slide smoothly on the glass. A retaining pillar 411 projects from each of the two sides of the sensor unit 41 to cooperate with a retaining hole 421 opened in the frame 42 for positioning the sensor unit 41 on the frame 42.

However, the components of the conventional CIS scanning module are so many and it is inconvenient to assemble, moreover, the tolerances are accrued and then the precision is affected, the cooperation between the sensor unit 41 and the frame 42 is unfirm, the sensor unit 41 is liable to shake when scanning, as a result, it will create noise and lead to a scanning image of bad quality.

### SUMMARY OF THE INVENTION

Accordingly, an object of the present invention is to provide a scanning module, comprising a sensor unit and a supporting base. The sensor unit has a top surface, a bottom surface, a front surface and a back surface. A positioning pillar is projected from the middle portions of the front surface and the back surface of the contact image sensor unit respectively. The supporting base has a guiding portion, a positioning board mounted on the guiding portion, the two sides of the positioning board extend sideward and bends upward to form an elastic arm respectively, the sensor unit is placed on the positioning board of the supporting base and the elastic arm elastically contacts the bottom surface of the sensor unit. The middle portions of the front side and the back side of the positioning board extend upward to form a pair of clip pieces vertical to the positioning board, a positioning cavity is opened in the clip piece for matching with the positioning pillar.

As described above, the two sides of the supporting base of the scanning module of the present invention have an elastic arm respectively, the elastic arm contacts the sensor unit directly and makes sure that the sensor unit contacts the glass tightly.

### BRIEF DESCRIPTION OF THE DRAWINGS

The present invention will be apparent to those skilled in the art by reading the following description of a preferred embodiment thereof, with reference to the attached drawings, in which:

FIG. 1 shows a conventional CIS scanning module;

FIG. 2 is an exploded view of a scanning module of a first embodiment according to the present invention;

FIG. 3 is a cross-sectional view of the scanning module shown in FIG. 2;

FIG. 4 is an exploded view of a scanning module of a second first embodiment according to the present invention;

FIG. 5 is a cross-sectional view of the scanning module shown in FIG. 4;

FIG. 6 is an exploded view of a scanning module of a third embodiment according to the present invention; and

FIG. 7 is a cross-sectional view of the scanning module shown in FIG. 6.

### DETAILED DESCRIPTION OF THE PREFERRED EMBODIMENT

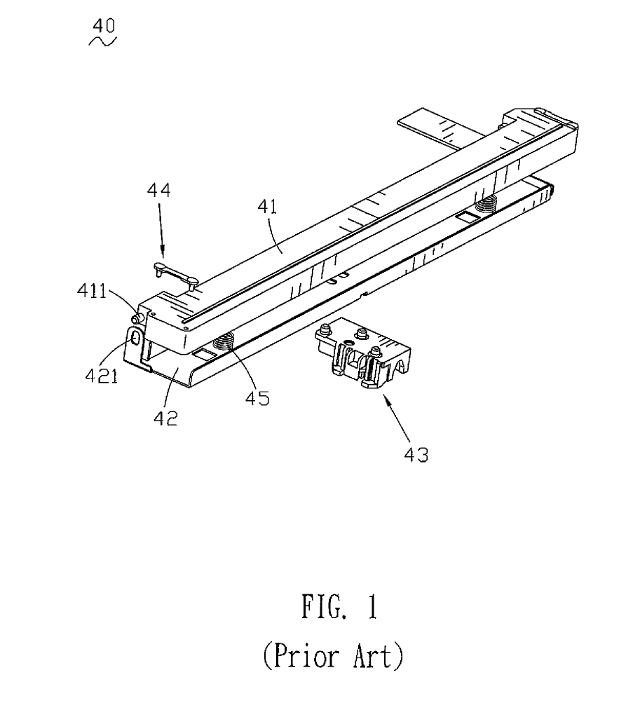

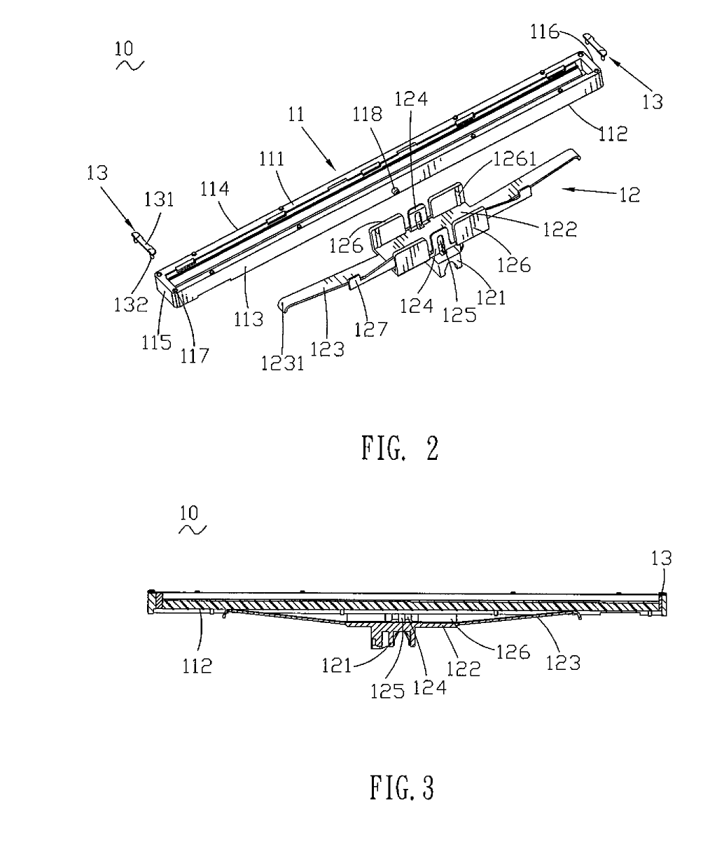

Please refer to FIGS. 1-2, a first embodiment of the present invention is shown. A scanning module 10 includes a sensor unit 11, a supporting base 12 and a pair of long-wearing piece 13.

The sensor unit 41 is about cuboid-shaped, having a top surface 111, a bottom surface 112, a front surface 113, a back surface 114, a left surface 115 and a right surface 116. The top surface 111 contacts with a document-supporting board of a scanner (not shown). The sensor unit 11 defines a locking hole 117 at each corner of the top surface 111, a positioning pillar 118 projects from the middle portions of the front surface 113 and the back surface 114 respectively.

The supporting base 12 has a guiding portion 121, a rectangular positioning board 122 is mounted on the guiding portion 121, the middle portions of the two sides of the positioning board 122 extend sideward and bends upward to form an elastic arm 123 respectively, the end of the elastic arm 123 further bends downwards to form a contact portion 1231. The middle portions of the front side and the back side of the positioning board 122 extend upward to form a pair of clip pieces 124 vertical to the positioning board 122, a positioning cavity 125 is opened in the clip piece 124. The front side and the back side of the positioning board 122 further extend upward to form a pair of positioning pieces 126 respectively at the two sides of the clip piece 124, the inner surface of the positioning piece 126 protrudes to form a positioning protuberance 1261, the positioning piece 126 at the front side extends sideward to form a positioning arm 127 having a hook portion at the free end.

The long-wearing piece 13 has a connecting piece 131 with two arc-shaped ends, each of the two ends projects downwards to form a locking arm 132.

When the scanning module 10 of the present embodiment is assembled, the sensor unit 11 is placed on the positioning board 122 of the supporting base 12 and arranged between the positioning pieces 126 and the clip pieces 124. Then the positioning pillar 118 of the contact image sensor unit 11 is inserted into the positioning cavity 125 of the clip piece 124, the positioning arm 127 contacts with the front surface 113 and the contact portion 1231 of the elastic arm 123 elastically contacts with the bottom surface 112 of the contact image sensor unit 11. Next, the locking arm 132 of the long-wearing piece 13 is inserted into the locking hole 117 to position the long-wearing piece 13 on the top surface 111 of the contact image sensor unit 11.

The elastic arm 127 elastically contacts with the contact image sensor unit 11, thereby, the contact image sensor unit 11 contacts with the positioning protuberance 1261 tightly for making sure of the stability of the movement of the contact image sensor unit 11. The positioning pillar 118 is inserted into the positioning cavity 125 and the contact portion 1231 of the elastic arm 123 elastically presses the contact image sensor unit 11 upwards, for making sure of the stability of the vertical direction of the contact image sensor unit 11 and avoiding the shake of the contact image sensor unit 11 when moving.

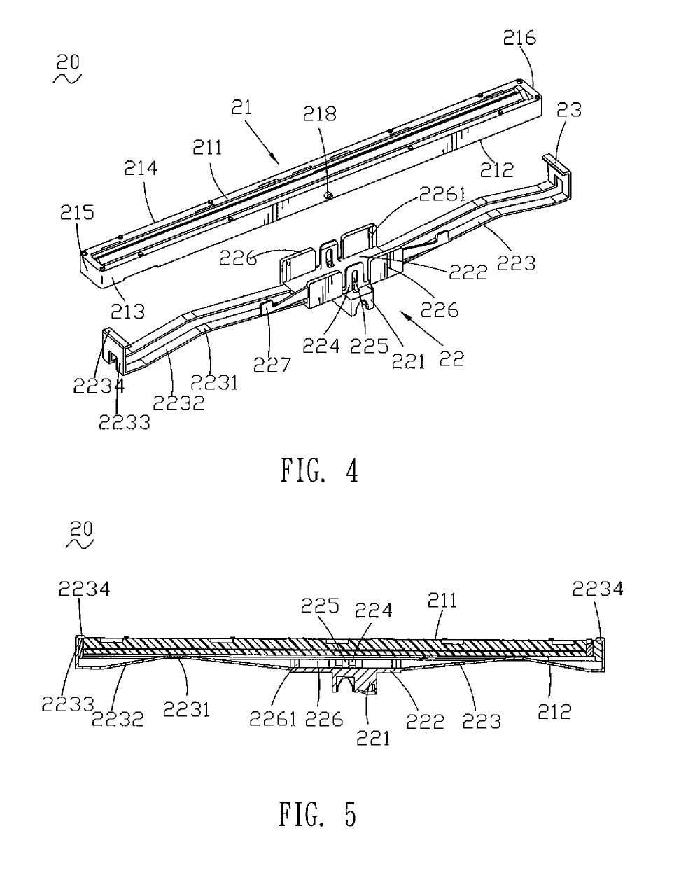

FIGS. 4-5 show a scanning module 20 of a second embodiment according to the present invention. The scanning module 20 includes a contact image sensor unit 21 and a supporting base 22.

The structure of the contact image sensor unit 21 of the present embodiment is similar to the contact image sensor unit 11 of the first embodiment, having a top surface 211, a bottom surface 212, a front surface 213, a back surface 214, a left surface 215 and a right surface 216. A positioning pillar 218 projects from the middle portions of the front surface 213 and the back surface 214 respectively.

The structure of the supporting base 22 of the present embodiment is similar to the supporting base 12 of the first embodiment, having a guiding portion 221, a rectangular positioning board 222 is mounted on the guiding portion 221, the middle portions of the two sides of the positioning board 222 extend sideward and bend upward to form a elastic arm 223 respectively, the elastic arm 223 has a contact portion 2231 at the end. The middle portions of the front side and the back side of the positioning board 222 extend upward to form a pair of clip pieces 224 vertical to the positioning board 222, a positioning cavity 225 is opened in the clip piece 224. The front side and the back side of the positioning board 222 further extend upward to form a pair of positioning pieces 226 at the two sides of the clip piece 224, the inner surface of the positioning piece 226 protrudes to form a positioning protuberance 2261, the positioning piece 226 at the front side extends sideward to form a positioning arm 227 having a hook portion at the free end. The difference between the second embodiment and the first embodiment is, the contact portion 2231 in the second embodiment bends downward and then extends to form a connecting portion 2232, the free end of the connecting portion 2232 extends upward to form an engaging piece 2233, the free end of the engaging piece 2233 further bends inward and is vertical to the engaging piece 2233 to form a blocking piece 2234.

The assemblage of the second embodiment of the present invention is similar to the assemblage of the first embodiment, the difference is, in the second embodiment, the two engaging pieces 2233 engage with the left surface 215 and the right surface 216 respectively, the clipping pieces 2234 clip on the top surface 211 of the contact image sensor unit 21 to make the supporting base 22 engage with the contact image sensor unit 21 firmly, the long-wearing piece 13 in the first embodiment is replaced by the clipping piece 2234 in the second embodiment.

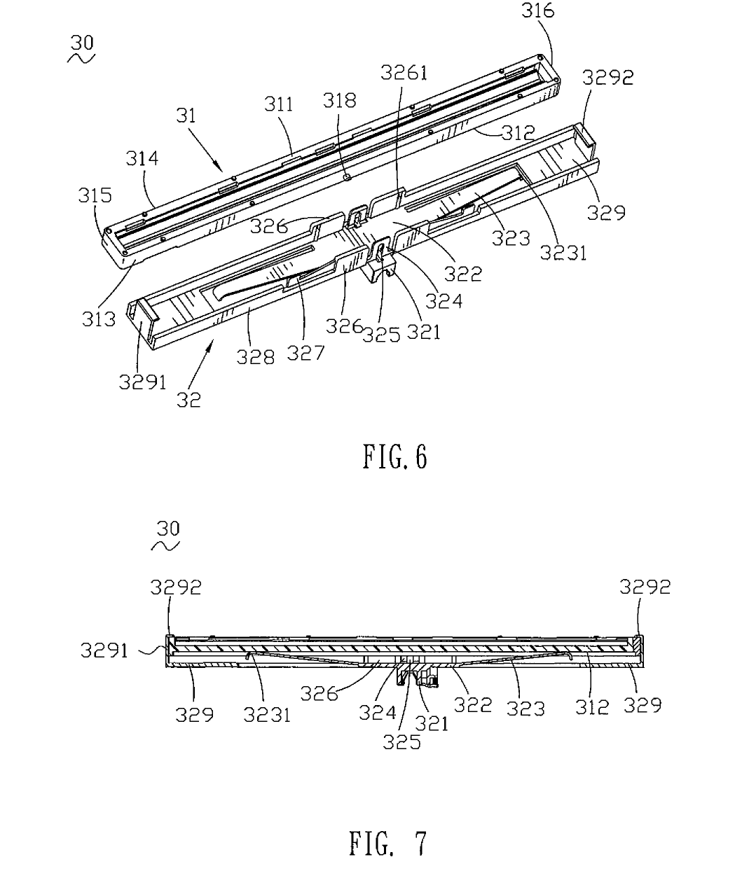

FIGS. 6-7 show a third embodiment of the present invention. The third embodiment includes a contact image sensor unit 31 and a supporting base 32.

The structure of the contact image sensor unit 31 of the present embodiment is similar to the contact image sensor unit 11 of the first embodiment, having a top surface 311, a bottom surface 312, a front surface 313, a back surface 314, a left surface 315 and a right surface 316. A positioning pillar 318 projects from the middle portions of the front surface 313 and the back surface 314 respectively.

The structure of the supporting base 32 of the present embodiment is similar to the supporting base 12 of the first embodiment, having a guiding portion 321, a rectangular positioning board 322 is mounted on the guiding portion 321, the middle portions of the two sides of the positioning board 322 extend sideward and bend upward to form a elastic arm 323 respectively. The elastic arm 323 has a contact portion 3231 at the end. The middle portions of the front side and the back side of the positioning board 322 extend upward to form a pair of clip pieces 324 vertical to the positioning board 322, a positioning cavity 325 is opened in the clip piece 324. The front side and the back side of the positioning board 322 further extend upward to form a pair of positioning pieces 326 at the two sides of the clip piece 324, the inner surface of the positioning piece 326 protrudes to form a positioning protuberance 3261, the positioning piece 326 at the front side extends sideward to form a positioning arm 327 having a hook portion at the free end. The difference between the third embodiment and the first embodiment is, the positioning piece 326 in the third embodiment further extends outward to form a blocking board 328, the two facing blocking boards 328 are connected together at the outer parts of the bottom by a connecting board 329, the outer end of the connecting board 329 extends upward to form a engaging piece 3291 which is vertical to the connecting board 329, the free end of the engaging piece 3291 bends inward to form a clipping piece 3292.

The assemblage of the third embodiment of the present invention is similar to the assemblage of the first embodiment, the difference is, in the third embodiment, the contact image sensor unit 31 is placed among the clip pieces 324, the positioning pieces 326 and the blocking boards 328, the engaging pieces 3291 engage with the left surface 315 and the right surface 316 respectively, the clipping piece 3292 clips on the top surface 311 of the contact image sensor unit 31 to make the supporting base 32 engage with the contact image sensor unit 31 firmly, the long-wearing piece 13 in the first embodiment is replaced by the clipping piece 3292 in the third embodiment.

The elastic arm 327 elastically contacts with the contact image sensor unit 31, thereby, the contact image sensor unit 31 contacts with the positioning protuberance 3261 tightly for making sure of the position of the motion direction of the contact image sensor unit 31. The positioning pillar 318 is inserted into the positioning cavity 325 for making sure of the stability of the vertical direction of the contact image sensor unit 31 and avoiding the shake of the contact image sensor unit 31 when moving.

As described above, the supporting base of the scanning module of the present invention includes an elastic arm respectively, the elastic arm contacts the contact image sensor unit directly and makes sure that the contact image sensor unit contacts the glass tightly.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A scanning module, comprising:
a contact image sensor unit having a top surface, a bottom surface, a front surface and a back surface, a positioning pillar being projected from the middle portions of the front surface and the back surface of the contact image sensor unit respectively;
a supporting base having a guiding portion, a positioning board mounted on the guiding portion, the two sides of the positioning board extending sideward and bending upward to form an elastic arm respectively, the contact image sensor unit being placed on the positioning board of the supporting base and the elastic arm elastically contacting with the bottom surface of the contact image sensor unit, the middle portions of the front side and the back side of the positioning board extending upward to form a pair of clip pieces vertical to the positioning board, a positioning cavity being opened in the clip piece for matching with the positioning pillar.

2. The scanning module as claimed in claim 1, wherein the front side and the back side of the positioning board further extend upward to form a pair of positioning pieces at the two sides of the clip piece, the positioning piece at the front side extends sideward to form a positioning arm for elastically contacting the front surface of the contact image sensor unit.

3. The scanning module as claimed in claim 2, further comprising a pair of long-wearing pieces, the long-wearing piece are positioned at the two sides of the top surface of the contact image sensor unit.

4. The scanning module as claimed in claim 3, wherein the long-wearing piece has a connecting piece with two arc-shaped ends, each of the two ends projects downwards to form a locking arm, the contact image sensor unit opens a locking hole at each corner of the top surface for matching with the locking arm.

5. The scanning module as claimed in claim 2, wherein the positioning piece farther extends outward to form a blocking board, the two facing blocking boards are connected together at the outer parts of the bottom by a connecting board, the outer end of the connecting board extends upward to form a engaging piece which is vertical to the connecting board, the free end of the engaging piece bends inward to form a clipping piece, the clipping piece clips on the top surface of the contact image sensor unit.

6. The scanning module as claimed in claim 2, wherein the elastic arm of the supporting base has a contact portion elastically contacting the bottom surface of the contact image sensor unit, the contact portion bends downward and then extends to form a connecting portion, the free end of the connecting portion extends upward to form an engaging piece, the free end of the engaging piece further bends inward and is vertical to the engaging piece to form a blocking piece clipped on the top surface of the contact image sensor unit.
